(19) United States
(12) Patent Application Publication
(10) Pub. No.: US 2018/0059475 A1
(43) Pub. Date: Mar. 1, 2018

(54) OPTICS COMPONENT WITH DOUBLE-LAYERED MICRO-LENS ARRAY

(71) Applicant: National Cheng Kung University, Tainan City (TW)

(72) Inventors: Yung-Chun LEE, Tainan City (TW); Hung-Liang CHIEN, Tainan City (TW)

(21) Appl. No.: 15/685,777

(22) Filed: Aug. 24, 2017

(30) Foreign Application Priority Data
Aug. 25, 2016 (TW) 105127612

(51) Int. Cl. G02F 1/1335; G02B 5/18; G02B 3/00

(52) U.S. Cl. CPC G02F 1/133526; G02B 5/188; G02F 2001/13356; G02B 3/0062; G02B 3/0012; G02B 3/0056

(57) ABSTRACT

An optics component with double-layered micro-lens array includes mainly complex pinhole structures in array arrangement on one substrate face, and either substrate face has an optical micro-lens array. Both optical micro-lens arrays include a plurality of aspheric micro-lenses corresponding to the pinhole structures. When the component is in use, a UV light reflected by a DMD wafer is focused onto each pinhole structure through the plurality of aspheric micro-lenses in the optical micro-lens array of one face of a crystal substrate, and a small spot is formed, which may begin to diffuse after passing through the pinhole structure. Then, the beam is focused onto another face by the plurality of aspheric micro-lenses of another substrate face to obtain a small spot with a small circular spot approaching physical diffraction limit. The formed spot arrays can be applied to the scanning maskless and direct-write exposure lithography process.

### BACKGROUND OF THE INVENTION

### 1. Field of the Invention

The present invention relates to an optics component used in maskless lithograph technique, more particularly, to an optics component with double-layered micro-lens array capable of supplanting or reducing directly the use of optical imaging mirror groups and enhancing the solution capability of maskless lithograph technique as well as reducing exposure energy loss.

### 2. Description of the Prior Art

Maskless lithograph technique taking DMD (Digital Mirror Device) as its core can be divided in two categories: (1) Image forming, and (2) Light point array scanning.

Among them, the maskless lithograph technique using light point array scanning mainly projects an image from a UV source to a first imaging group through DMD, utilizes the first imaging mirror group to project a digital optical image formed by the source and DMD to a spatial filter with micro-lens array, and then employs a second imaging mirror group to image again the digital optical image through the spatial filter with micro-lens array onto a substrate surface spin-coated with a PR layer for UV exposure of PR.

However, during the second imaging mirror group images the digital optical image through the spatial filter with micro-lens array onto a substrate surface spin-coated with a PR layer, some UV light energy will be diffused and the quality of the second imaging mirror group may affect the imaging quality, even causing deformation and distortion in imaging.

In light of various drawbacks of above maskless lithograph technique using light point array scanning, the inventor of this case urgently conceives and improves for innovation, and after several years of studying earnestly, finally develops the optics component with double-layered micro-lens array of the present document successfully.

### SUMMARY OF THE INVENTION

To solve above traditional technical problem, one purpose of the present invention is to provide an optics component with double-layered micro-lens array capable of effectively improving utilization of light energy. To solve above traditional technical problem, one purpose of the present invention is to provide an optics component with double-layered micro-lens array capable of effectively improving the solution ability of maskless lithography System.

To achieve above purpose, the optics component with double-layered micro-lens array of the present invention mainly comprises a substrate, a first optical micro-lens array and a second optical micro-lens array; the substrate is a glass and quartz material and has a blocking layer deposited by an evaporator on the surface of one side, and an adhesive layer deposited similarly by the evaporator is between the substrate and the blocking layer; both the blocking layer and the adhesive layer have a pinhole structure in an array arrangement, the first optical micro-lens array being provided on the surface of one side of the substrate and the second optical micro-lens array being provided on the surface of another side of the substrate opposing to the first optical micro-lens array.

Wherein the first optical micro-lens array includes a plurality of first aspheric micro-lenses corresponding to the pinholes respectively.

Wherein the second optical micro-lens array includes a plurality of second aspheric micro-lenses corresponding to the pinholes respectively.

The above first optical micro-lens array is provided on one face of the substrate having the adhesive layer and the blocking layer, or the second optical micro-lens array is provided on one face of the substrate having the adhesive layer and the blocking layer.

### BRIEF DESCRIPTION OF THE DRAWINGS

With reference to the detailed description and figures related to the present invention, the technical contents and purpose as well effects of the present invention can be further understood; the related figures are:

FIG. 1 is a stereoscopic schematic view illustrating the appearance of the optics component with double-layered micro-lens array in the present invention;

FIG. 2 is a stereoscopically exploded schematic view of the optics component with double-layered micro-lens array in the present invention;

FIG. 3 is a schematic view illustrating the use status of the optics component with double-layered micro-lens array in the present invention;

FIG. 4 is a schematic view illustrating the optical path of the optics component with double-layered micro-lens array in the present invention.

### SYMBOL DESCRIPTION OF MAIN ELEMENT

1 optics component with double-layered micro-lens array

11 substrate

111 pinhole structure

112 adhesive layer

113 blocking layer

12 first optical micro-lens array

121 first aspheric micro-lens

13 second optical micro-lens array

131 second aspheric micro-lens

2 UV source

3 reflecting mirror

4 DMD wafer

### DETAILED DESCRIPTION OF THE PREFERRED EMBODIMENT

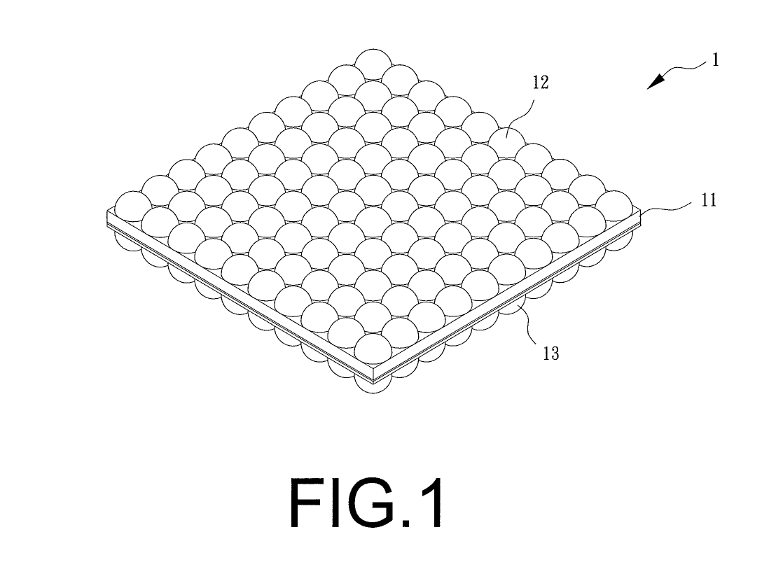

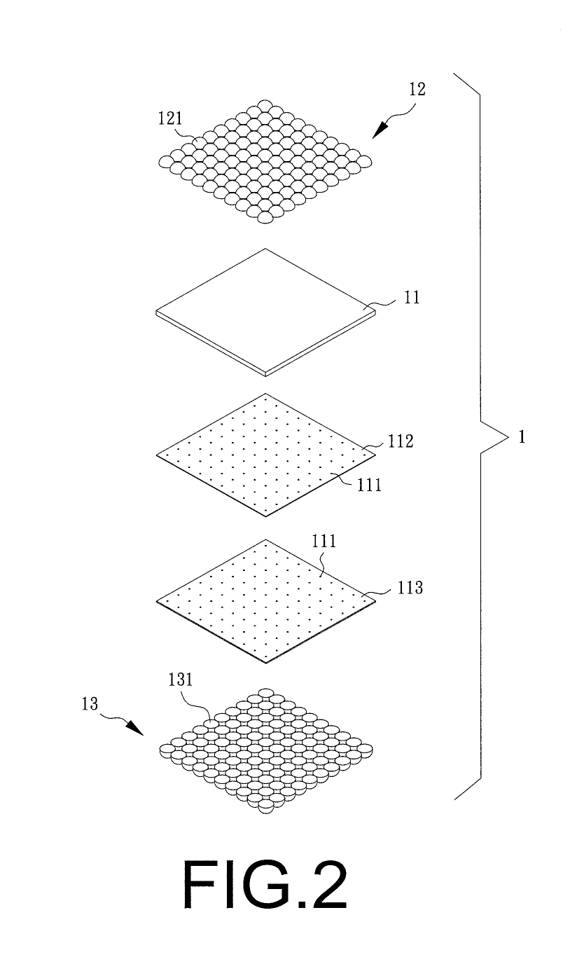

Specific embodiment case will be described in the following to illustrate the implementation of this case, which doesn't limit the scope of the present invention. Reference now will be made to FIG. 1-2, the optics component with double-layered micro-lens array of the present invention is a group of optics components with pinhole array structure similar to the spatial filter which is made on a transparent substrate and the positive and negative sides of the component are combined with a micro-lens array, so as to achieve an optics component with structure of “microlens-filter-microlens”. The component mainly comprises a substrate 11, a first optical micro-lens array 12 and a second optical micro-lens array 13; the substrate 11 has a plurality of pinhole structures in array arrangement on the surface of one side; the first optical micro-lens array 12 is provided on one face of the substrate 11 and includes a plurality of first aspheric micro-lenses 121 corresponding to the plurality of pinhole structures 111 respectively; the second optical micro-lens array 13 is provided on another face of the substrate 11 opposing to the first optical micro-lens array 12 and includes a plurality of second aspheric micro-lenses 131 corresponding to the plurality of pinhole structures 111 respectively. The optics component with double-layered micro-lens array 1 of the present invention is mainly made by fabricating firstly the plurality of pinhole structures 111 in array arrangement on the substrate 11 with 2 inches diameter and 260 μm thickness, and then fabricating the first optical micro-lens array 12 and the second optical micro-lens array 13. The process is described as below:
a. First, depositing 10 nm Cr and 50 nm thicker Au onto the substrate 11 as the adhesive layer 112 of other metals and glasses and as the blocking layer 113 of UV light respectively by an evaporator.
b. Then, fabricating the plurality of pinhole structures in array arrangement 111 through a standard yellow light lithography process;
c. Spin-coating a layer of positive photoresist (AZ1800) with 1.4 μm on the metal layer, and covering a glass mask in pinhole array with 7 μm size and 110 μm cycle for exposure. After post exposure baking and development process, forming the pinhole structure in array arrangement 111 of the same size on the positive photoresist and etching Au or Cr to complete transfer of the pinhole array on the adhesive layer 112 and blocking layer 113.
D. Spin-coating a layer of SU-8 negative photoresist (SU-8 3025) with 25 μm thickness onto another face of the substrate 11, and after soft baking exposure and hard baking, the SU-8 photoresist is ensured to be secured on the quartz glass.
E. Finally, pasting an OCA tape used as polymer PC material onto that face of the pinhole structure in array arrangement 111. After preparation of the test piece, fabricating the first optical micro-lens array 12 and second optical micro-lens array 13 by Excimer Laser Bi-convex Tract Fabrication Technique; each of the first aspheric micro-lenses of the first optical micro-lens array 12 and each of the second aspheric micro-lenses of the second optical micro-lens array 13 have a diameter and cycle of 110 μm.

Wherein in the process of fabricating the first optical micro-lens array 12 and second optical micro-lens array 13 by Excimer Laser Bi-convex Tract Fabrication Technique, a laser beam is emitted continuously along two axial directions perpendicular to each other by the laser through mask pattern, each emission having a 32 ns cycle, and when the laser fluence is 100 mJ/cm2, the process depth is 0.065 μm, the laser repetition frequency being 5 Hz, while the interval distance of each laser emission being 2 μm and the moving speed of the substrate is 10 μm/s. In order to align the micro-lens array with the optical axis of the pinhole array properly during the process, a CCD camera is added to help alignment. Whether the pinhole array is on the process axis and is in the center can be directly observed from the CCD. After completion, observing the intensity and alignment of each spot on X, Y axis from below the 10× objective lens of optical microscope. And observing its intensity and process accuracy with the 20× objective lens of optical microscope.

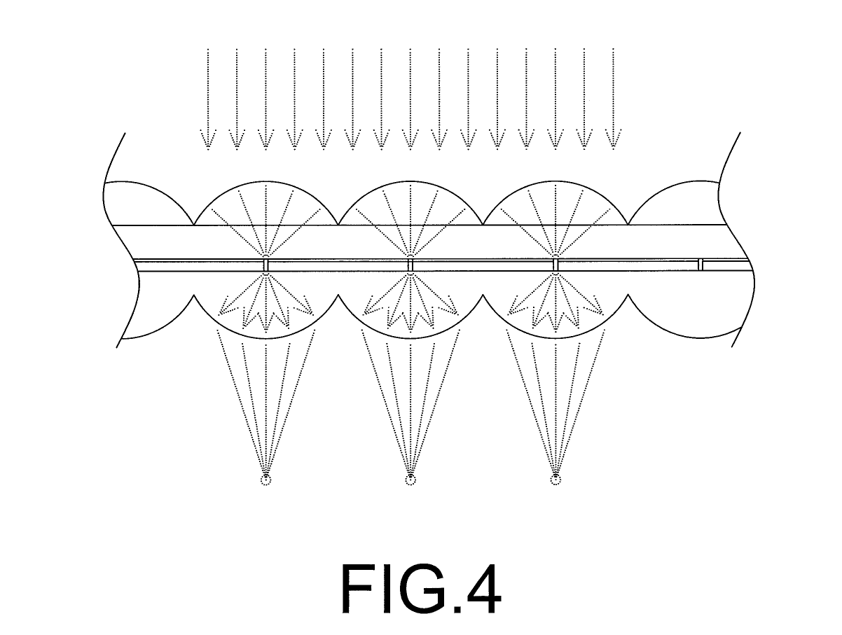

Finally, utilizing the optical microscope to complete the size of spot on LED and MLSFA final focusing plane, and adjusting LED intensity and object lens to find that the focusing plane is at 210 μm; the spot peak value of 4×3 array under 20× object lens is 1.95 W/cm2; single spot energy distribution through lenses on the focusing plane is shown in the X-X̂, Y-Ŷ axis profile of FIGS. 4b and 4c. When the energy level is 1/e2, the spot size is about 10.24 μm and 14.1 μm; when the energy level is FWHM, the spot size is about 7.05 μm and 8.5 μm.

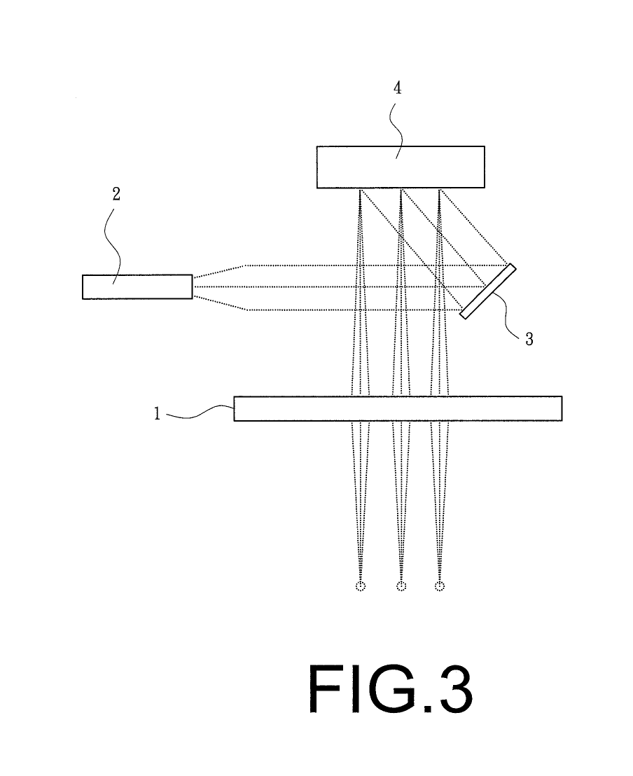

With reference to FIG. 3-4, when the optics component with double-layered micro-lens array 1 of the present invention is in use, a UV light emitted from the light source 2 is projected onto the DMD wafer 4 at a specific angle through a reflecting mirror 3 after dodging and collimation, and the UV light is focused onto respective pinhole structure 111 through the plurality of aspheric micro-lenses 121 of the first optical micro-lens array 12 firstly and a small spot is formed which may begin to diffuse after passing through the pinhole structure 111; then the beam is again focused onto another face by the plurality of second aspheric micro-lenses 131 of the second optical micro-lens array 13 to obtain a small spot with a small circular spot approaching physical diffraction limit. Wherein the pinhole structure 111 is similar to a spatial filter, aiming at being able to filter and remove the incident non-parallel light source or the stray light at the edge of aspheric micro-lens for a good optical quality of the finally focused spot such as better spot roundness, more uniform spot energy distribution etc. In addition, the optics component with double-layered micro-lens array 1 of the present invention only has conversion interface among four glasses, and also thus reduces the interface reflection and absorption problems of UV light among lenses, thereby further improving the utilization efficiency of light energy. Further, the optics component with double-layered micro-lens array 1 of the present invention can be matched with a UV light source directly to be applied on the device of periodic beam pen lithography system; furthermore, it also has a significant advantage in improving the performance and reducing cost of the maskless lithography process device developed in recent years.

The above-mentioned detailed description aims to specifically illustrate one practicable embodiment of the present invention, but the embodiment are not for limiting the patent scope of the present invention and all equivalent embodiments or modifications made without departing from the spirit of the present invention shall be contained within the patent scope of the present invention. Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An optics component with double-layered micro-lens array comprises:
a substrate having a plurality of pinhole structures on the surface of one side;
a first optical micro-lens array provided on one face of the substrate and including a plurality of first aspheric micro-lenses corresponding to the pinholes respectively;
a second optical micro-lens array provided on another face of the substrate opposing to the first optical micro-lens array and including a plurality of second aspheric micro-lenses corresponding to the pinholes respectively.

2. The optics component with double-layered micro-lens array according to claim 1, wherein the substrate is a glass or quartz material, and the surface on one side of the substrate has a blocking layer, on which the pinhole structures is arranged in an array.

3. The optics component with double-layered micro-lens array according to claim 2, wherein an adhesive layer is between the substrate and the blocking layer.

4. The optics component with double-layered micro-lens array according to claim 3, wherein the adhesive layer is deposited on the surface of the substrate by an evaporator.

5. The optics component with double-layered micro-lens array according to claim 2, wherein both the blocking layer and the adhesive layer are opaque layers.

6. The optics component with double-layered micro-lens array according to claim 3, wherein both the blocking layer and the adhesive layer are opaque layers.

7. The optics component with double-layered micro-lens array according to claim 1, wherein the first optical micro-lens array is provided on one face of the substrate having the pinhole structures in array arrangement.

8. The optics component with double-layered micro-lens array according to claim 1, wherein the second optical micro-lens array is provided on one face of the substrate having the pinhole structures in array arrangement.
